(19) United States
(12) Patent Application Publication
(10) Pub. No.: US 2022/0107037 A1
(43) Pub. Date: Apr. 7, 2022

(54) PIPE CHAIN SYSTEM

(71) Applicant: QF Innovations Inc., Kelowna (CA)

(72) Inventor: Kevin ADAMS, Kelowna (CA)

(21) Appl. No.: 17/491,830

(22) Filed: Oct. 1, 2021

(30) Foreign Application Priority Data
Oct. 2, 2020 (CA) 3 095 015

(51) Int. Cl. F16L 1/10; F16G 15/12; F16G 13/14

(52) U.S. Cl. CPC F16L 1/10; F16G 13/14; F16G 15/12

(57) ABSTRACT

A pipe chain system has a chain that is made of a plurality of chain links. Each chain link has a body. The body has a male end and a female end such that the male end matingly engages with the female end of an adjacent chain link. The body has an arcuate underside. The arcuate underside corresponds to a portion of a pipe diameter to which the chain is attached. A pin connection is provided for mating each mating engagement of the male end and the female end of the adjacent chain links such that the chain links are hingedly connected to each other.

### FIELD OF THE DISCLOSURE

The present application relates generally to a pipe chain system, more particularly it relates to a pipe chain system with interchangeable chain links.

### BACKGROUND

This section provides background information to facilitate a better understanding of the various aspects of the invention. It should be understood that the statements in this section of this document are to be read in this light, and not as admissions of prior art.

Pipe is commonly used in a variety of industries and requires preparation, cutting and fitting, welding and other procedures for its use. Preparing a pipe for use can be a challenging process with the pipe requiring linear and lateral adjustments to be made to properly align adjacent pipe sections in end to end relation. This process often requires the use of several different tools to properly align and connect adjacent pipe sections. The use of several different tools can greatly slow the process of aligning and connecting adjacent pipe sections. The different styles, sizes and capabilities of the varying traditional tools makes, what should be, the simple task of aligning and adjusting pipe joints a time consuming task. Traditional tools also tend to be either task or size specific and are generally not capable of completing both the required tasks of pipefitting, alignment and position.

### BRIEF SUMMARY

There is provided a pipe chain system that has chain made of a plurality of chain links. Each chain link has a body. The body has a male end and a female end such that the male end matingly engages with the female end of an adjacent chain link. The body has an arcuate underside. The arcuate underside corresponds to a portion of a pipe diameter to which the chain is being attached. A pin connection is provided for mating each mating engagement of the male end and the female end of the adjacent chain links such that the chain links are hingedly connected to each other.

In one embodiment, the body of the chain link has a flat topside.

In one embodiment, the body is machined from a sold piece of steel.

In one embodiment, each of the male end and the female end of the body have apertures positioned horizontally through the body such that the pin connection engages the apertures to cause mating of the male end and the female end of the adjacent chain links.

In another embodiment, the body of the chain link has a topside having a t-slot.

In another embodiment, a link ear having a base and a pair of upright arms is provided. The upright arms have component apertures in spaced alignment with each other. The link ear is fastened to a topside of the body. The link ear may be fixedly fastened to the topside of the body or may be rotatably fastened to the topside of the body.

In one embodiment, an actuator, such as a jack, cylinder or turnbuckle, is connected to a first body having the first link ear on a first chain and a second body having the second link ear on a second chain such that the actuator applies and releases a lateral load force on the first chain and the second chain.

In one embodiment, a clamp assembly is provided. The clamp assembly has a trunnion attached to the body of one of the chain links. The trunnion supports a first end of a threaded rod. A hooked body is supported on a second end of the threaded rod. An adjustment knob is positioned on the threaded rod. Rotation of the adjustment knob in a first direction causes the trunnion and the hooked body to move towards each other. Rotation of the adjustment knob in a second direction causes the trunnion and the hooked body to move away from each other. The hooked body is hingedly attachable to one of the chain links.

In one embodiment, an alignment bar as provided. The alignment bar has a base and two tap blocks attached to the base. The base is attachable to at least one of the chain links and the two tap blocks are positioned in opposition to each other.

There is also provided a pipe chain system that has first chain and a second chain. Each of the first chain and the second chain have a plurality of chain links. Each chain link has a body. The body has a male end and a female end such that the male end matingly engages with the female end of an adjacent chain link. The body has an arcuate underside. The arcuate underside corresponds to a portion of a pipe diameter to which the plurality of chain links is being attached. A pin connection is provided for mating each mating engagement of the male end and the female end of the adjacent chain links such that the chain links are hingedly connected to each other. The first chain is positioned adjacent an end of a first pipe and the second chain is positioned adjacent an end of a second pipe. The end of the first pipe and the end of the second pipe are adjacent to each other. An alignment bar extends from the first chain to the second chain such that the alignment bar extends over the end of the first pipe and the end of the second pipe for aligning the first pipe and the second pipe. The alignment bar is attachable to the chain link on each of the first chain and the second chain.

In one embodiment, at least the chain link to which the alignment bar is attachable on both the first chain and the second chain has a topside that has a t-slot. The alignment bar has a base corresponding in shape to the t-slot such that the base of the alignment bar is slidingly engageable within the t-slot.

In one embodiment, each of the male end and the female end of the body has apertures positioned horizontally through the body such that the pin connection engages the apertures to cause mating of the male end and the female end of an adjacent chain link.

In another embodiment, a link ear having a base and a pair of upright arms is provided. The upright arms has component apertures in spaced alignment with each other. The link ear is fastened to a topside of the body. The link ear may be fixedly fastened to the topside of the body or may be rotatably fastened to the topside of the body.

In one embodiment, an actuator, such as a jack, is connected to a first body having the first link ear on the first chain and a second body having the second link ear on the second chain such that the actuator applies and releases a lateral load force on the first chain and the second chain.

In one embodiment, a clamp assembly is provided. The clamp assembly has a trunnion attached to the body of one of the chain links. The trunnion supports a first end of a threaded rod. A hooked body is supported by a second end of the threaded rod. An adjustment knob is positioned on the threaded rod. Rotation of the adjustment knob in a first direction causes the trunnion and the hooked body to move towards each other. Rotation of the adjustment knob in a second direction causes the trunnion and the hooked body to move away from each other. The hooked body is hingedly attachable to one of the chain links.

In one embodiment, the alignment bar includes a tap block that has at least one tapped hole. Each of the tapped holes accepts a bolt. The bolts are positioned above at least one of the first pipe and the second pipe to be aligned. The bolts apply a pushing force on at least one of the first pipe and the second pipe.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a perspective view of a chain link having a flat topside.

FIG. 2 is a side elevation view of the chain link having a flat topside shown in FIG. 1.

FIG. 3 is a top plan view of a plurality of chain links mated to each other.

FIG. 4 is a perspective view of a chain link having a t-slot.

FIG. 5 is a side elevation view of the chain link having a t-slot shown in FIG. 4.

FIG. 6 is a top plan view of the chain link having a t-slot shown in FIG. 4.

FIG. 7 is a perspective view of a chain link having a link ear.

FIG. 8 is a side elevation view of the chain link having a link ear shown in FIG. 7.

FIG. 9 is a top plan view of the chain link having a link ear shown in FIG. 7.

FIG. 10 is a side elevation view of a jack connected to two chains.

FIG. 11 is a perspective view of a clamp assembly.

FIG. 12 is a side elevation view of the clamp assembly shown in FIG. 11.

FIG. 13 is a top plan view of the clamp assembly shown in FIG. 11.

FIG. 14 is a side elevation view of the clamp assembly shown in FIG. 11 attached to chain links.

FIG. 15 is a perspective view of a single alignment bar.

FIG. 16 is a side elevation view of the single alignment bar shown in FIG. 15.

FIG. 17 is a top plan view of the single alignment bar shown in FIG. 15.

FIG. 18 is a side elevation view of the single alignment bar shown in FIG. 15 used in association with a chain.

FIG. 19 is a side elevation view of the single alignment bar shown in FIG. 15 used in association with a chain and positioned on a pipe.

FIG. 20 is a side elevation view of the single alignment bar shown in FIG. 15 used in association with a first chain and a second chain and positioned on a pipe.

FIG. 21 is a perspective view of a double alignment bar.

FIG. 22 is a side elevation view of the double alignment bar shown in FIG. 19.

FIG. 23 is a perspective view of the double alignment bar shown in FIG. 19 used in association with a first chain and a second chain.

FIG. 24 is a side elevation view of the double alignment bar shown in FIG. 19 used in association with a first chain and a second chain and positioned on a pipe.

### DETAILED DESCRIPTION OF THE PREFERRED EMBODIMENTS

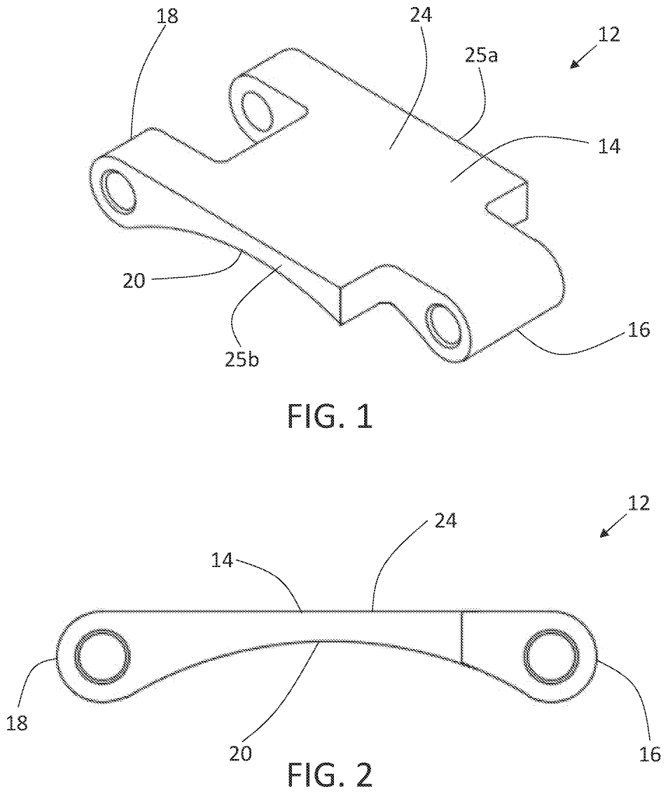

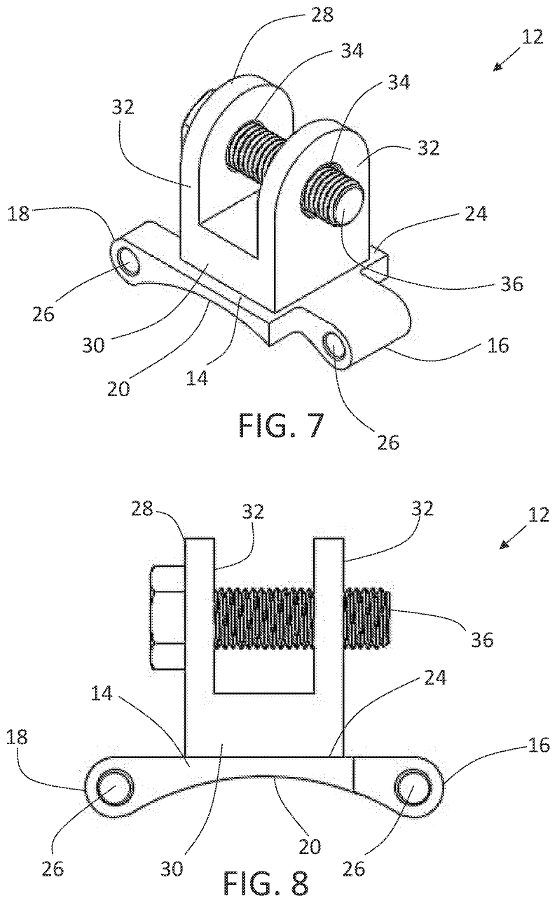

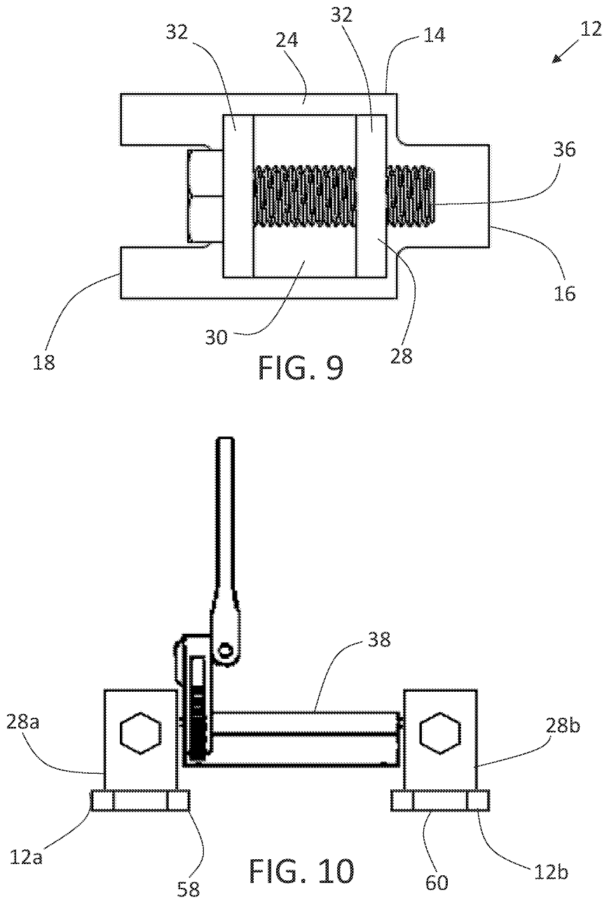

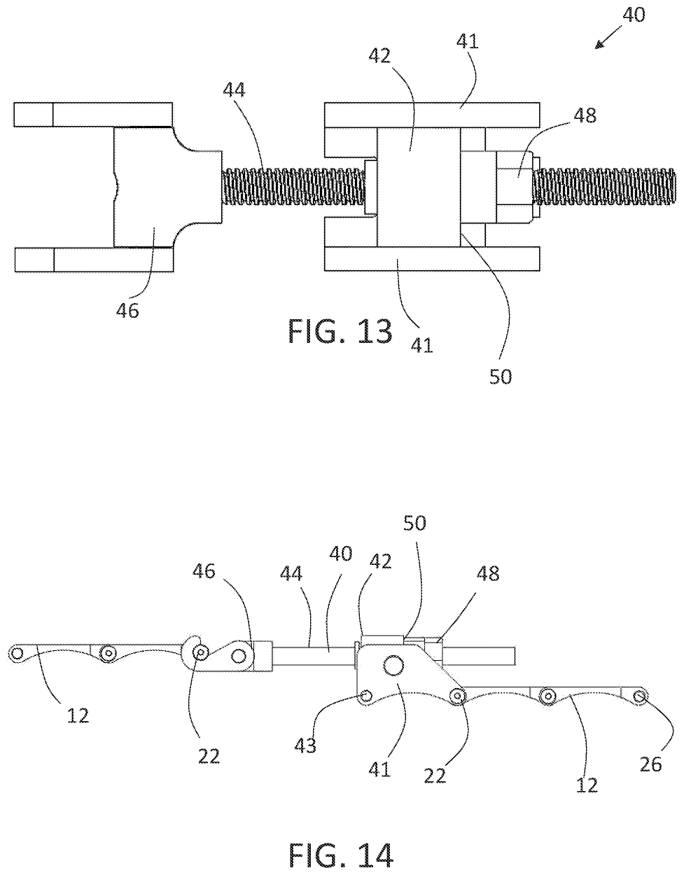

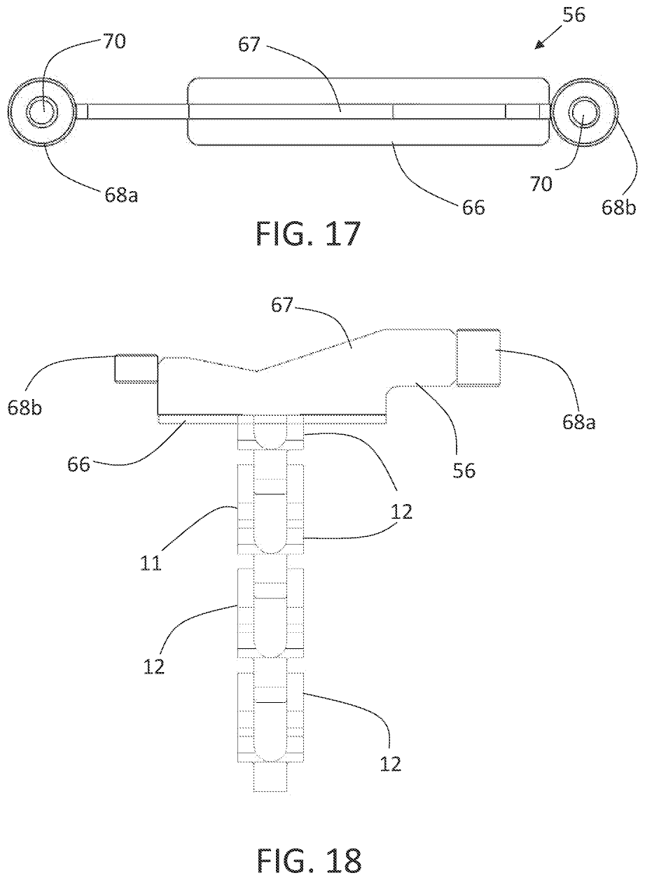

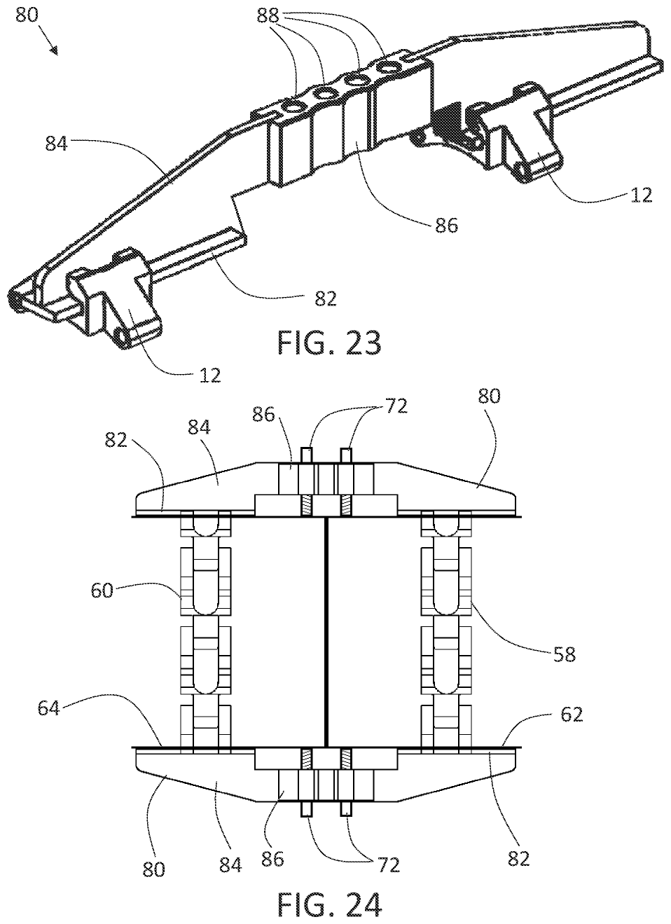

A pipe chain system, generally identified by reference numeral 10, will now be described with reference to FIG. 1 through FIG. 24.

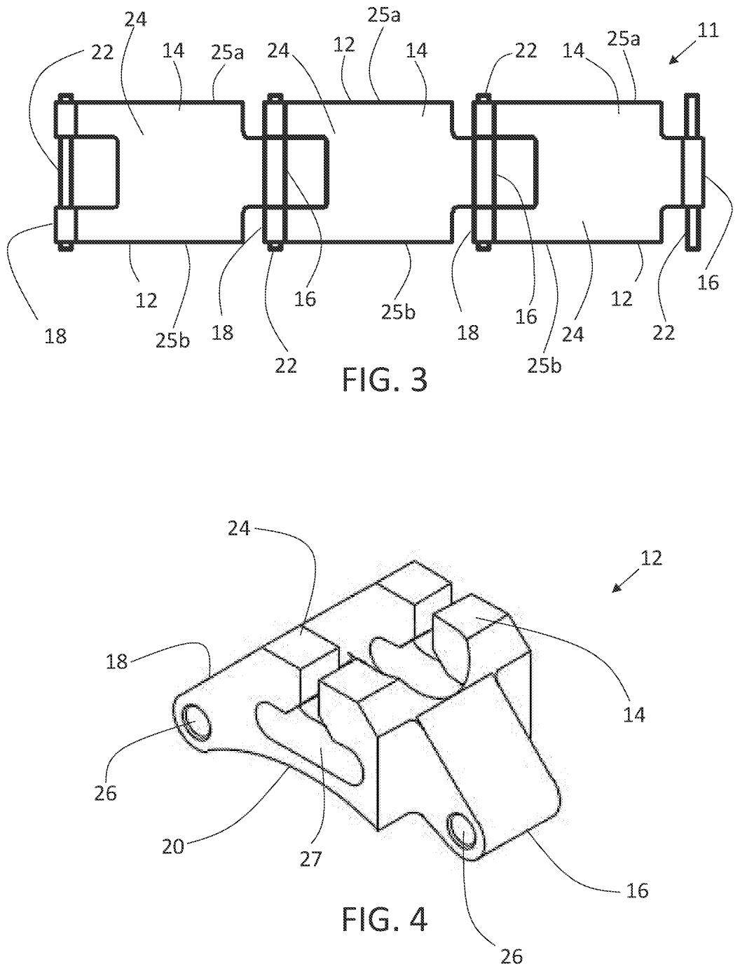

Referring to FIG. 3, a pipe chain system 10 has chain 11 made of a plurality of chain links 12. Each chain link 12 has a body 14. Body 14 has a male end 16 and a female end 18. Male end 16 matingly engages with female end 18 of an adjacent chain link 12. Referring to FIG. 1 and FIG. 2, body 14 has an arcuate underside 20. Arcuate underside 20 helps to prevent body 14 from bending around a pipe and taking on the particular size of the pipe when tension is applied to pipe chain system 10. The arc of arcuate underside 20 may determine the minimum pipe size to which chain links 12 are suitable, however the arc of arcuate underside 20 can be different from the arc of the portion of the pipe diameter to which chain links 12 forming chain 11 are attached. The arcuate underside has an arc length equal to or smaller than an arc length corresponding to a portion of a pipe diameter to which the plurality of chain links is being attached A pin connection 22 is provided for mating each mating engagement of male end 16 and female end 18 of adjacent chain links 12 such that chain links 12 are hingedly connected to each other. Pin connection 22 may be removed and installed to allow for additional or fewer chain links 12 to be included in chain 11 for size adjustments. Chain 11 may be any length. Chain links 12 are preferably machined from a solid piece of steel and are connected together to create an endless chain when mated together using pin connection 22. The width of chain links 12 and tight tolerances when machining enables a lateral load to be applied without a substantial side deflection that is common with traditional chains. As an example only, chain links may be 2.5 inches wide to provide lateral force stability and significant link and pipe surface contact. Tolerances of a few thousandths of an inch ensures minimal movement between chain links 12. Arcuate underside 20 helps to prevent bending when chain 11 of chain links 12 is clamped tight around a pipe. In the embodiment shown in FIG. 1 through FIG. 3, body 14 of chain link 12 has a topside 24 that is flat. While flat topside 24 allows for a flat topside to work from when chain links 12 are clamped around a pipe, it will be understood by a person skilled in the art that different shaped topsides may be used for different purposes.

In the embodiment shown in FIG. 2, each of male end 16 and female end 18 of body 14 have apertures 26 that are positioned horizontally through body 14 such that pin connections 22, shown in FIG. 3, engage apertures 26 to cause mating of male end 16 and female end 18 of adjacent chain links 12. It will be understood by a person skilled in the art that pin connection 22 may connect male end 16 and female end 18 of adjacent chain links 12 in any other suitable way known to a person skilled in the art.

Referring to FIG. 3, pin connection 22 is preferably installed such that it extends outwards from either side 25a and 25b of chain link 12. It has been found that an outward extension of ½ an inch on either side 25a and 25b of chain link 12 is acceptable, however it will be understood that pin connection 22 may be flush with sides 25a and 25b, recessed within apertures 26 or extend farther outwards from sides 25a and 25b. It will also be understood that pin connection 22 may extend outwards from side 25a while being recessed within aperture on side 25b, extend outwards from side 25a while being flush with side 25b, or be recessed within aperture on side 25a while being flush with side 25b. A spacer may be installed on pin connections 22 to maintain proper positioning of pin connection within apertures 26.

In the embodiment shown in FIG. 4 through FIG. 6, body 14 of chain link 12 has a topside 24 that has a t-slot 27. It is preferred that body 12 with a t-slot 27 be machined from a solid steel bar. T-slot 27 allows for the incorporation of components, such as jacks and alignment bars, to be attached to chain links 12. Chain links 12 with t-slots 26 can be incorporated into an endless chain with chain links 12 with flat topsides 24 or every chain link 12 in an endless chain may have t-slots 26.

In the embodiment shown in FIG. 7 through FIG. 9, body 12 of chain link 12 may have a link ear 28 fastened to a topside 24 of body 12. Link ear 28 may be fixedly fastened to topside 24 or rotatably fastened to topside 24. In the embodiment shown, topside 24 is flat, however it will be understood by a person skilled in the art that topside 24 may be any shape. Link ear 28 has a base 30 and a pair of upright arms 32. Upright arms 32 have component apertures 34 in spaced alignment with each other. In the embodiment shown a component pin connection 36 passes through component apertures 34. Component pin connection 36 may be used to incorporate components, such as jacks, into pipe chain system 10. It will be understood by a person skilled in the art that components may be incorporated into pipe chain system 10 my any means known to a person skilled in the art.

In the embodiment shown in FIG. 10, a first body 12a with a first link ear 28a on a first chain 58 and a second body 12b with a second link ear 28b on a second chain 60 are positioned within the plurality of chain links. In the present embodiment, an actuator in the form of a jack 38 is connected to first link ear 28a and second link ear 28b. Actuators such as jack apply and release a lateral load force on pipe chain system 10. The lateral load force on pipe chain system 10 accommodates linear pipe movement for simultaneous alignment and positioning.

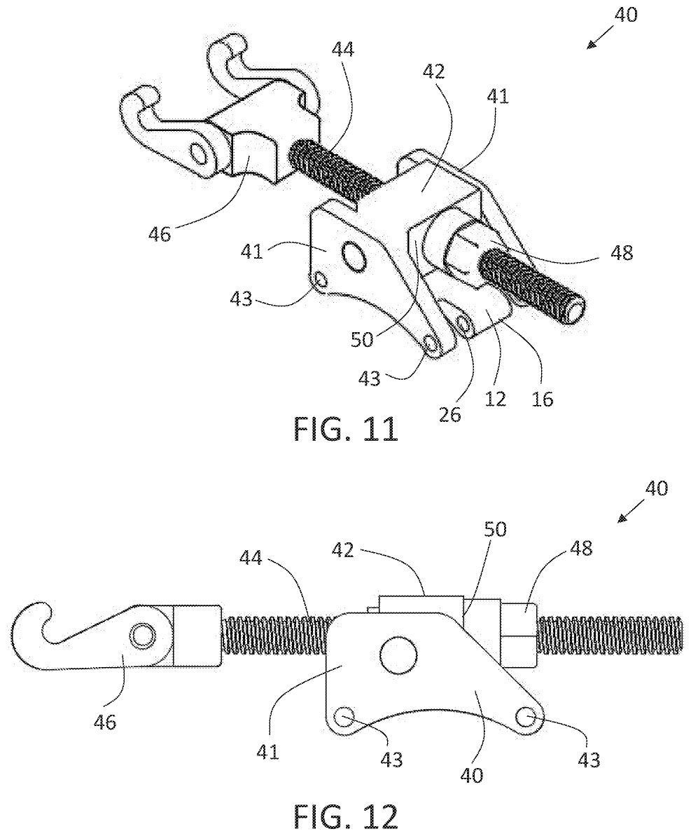

In the embodiment shown in FIG. 11 through FIG. 14, a clamp assembly 40 is provided. Clamp assembly 40 has a trunnion 42 that is attached to body 14 of one of chain links 12. It is preferred that trunnion 42 be capable of pivoting to assist in aligning of pipe chain system 10 when clamp assembly 40 is in use. It will be understood, however, that a non-pivoting trunnion 42 may also be used. In the embodiment shown, a pair of side panels 41 with apertures 43 are used to attach trunnion 42 to body 14. Apertures 43 align with apertures 26 such that a pin connection 22, shown in FIG. 3, may be used to attach trunnion 42 to body 14. Trunnion 42 supports a threaded rod 44. One end of threaded rod 44 is attached to a hooked body 46. An adjustment knob 48 is positioned on threaded rod 44 adjacent an exterior wall 50 of trunnion 42. It will be understood that adjustment knob 48 may be positioned on threaded rod 44 adjacent either trunnion 42 or hooked body 46 and still operate in the same manner.

Rotation of adjustment knob 48 in a first direction causes trunnion 42 and hooked body 46 to move towards each other. Rotation of adjustment knob 48 in a second direction causes trunnion 42 and hooked body 46 to move away from each other. Hooked body 46 is hingedly attachable to one of chain links 12. In the embodiment shown, hooked body 46 is attached to connection pin 22 of an adjacent chain link 12. It will be understood by a person skilled in the art that hooked body 46 may be sized to allow a connection to chain link 12 in any other suitable manner.

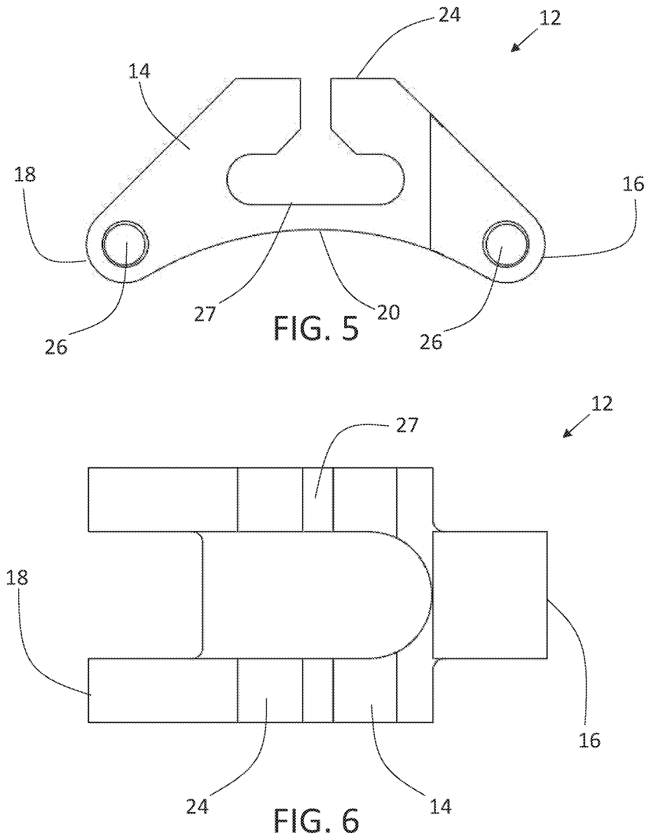

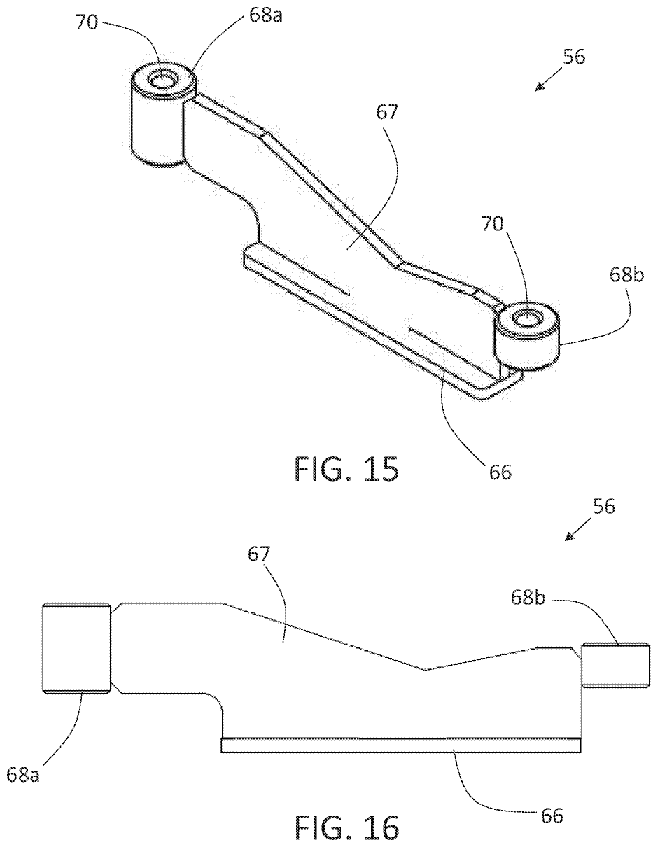

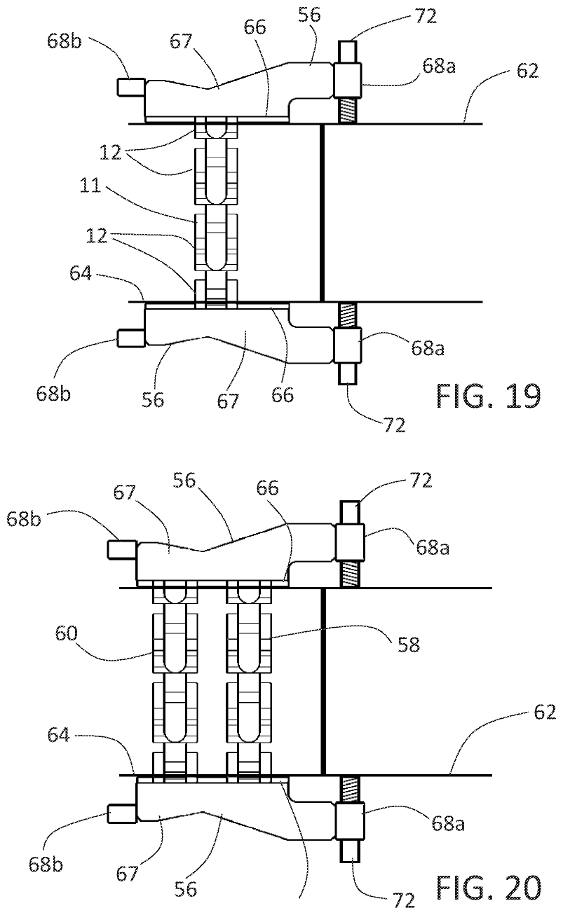

Referring to FIG. 18 and FIG. 19, single alignment bar 56 may be used in association with chain 11 to assist in aligning a first pipe 62 and a second pipe 64. Single alignment bar 56 has a base 66 that attaches to at least one of chain links 12. Referring to FIG. 15 through FIG. 17, in the embodiment shown, shape of base 66 corresponds in shape to t-slot 27, shown in FIG. 5. This allows base 66 of alignment bar 56 to be slidingly engageable within t-slot 27, shown in FIG. 5. It will be understood that base 66 may be attachable to chain link 12 in any other suitable way known to a person skilled in the art. Single alignment bar 56 has an elongated body 67 that is attached to base 66. Two tap blocks 68a and 68b are attached to elongated base 67 and positioned opposite of each other. Referring to FIG. 19, a bolt 72 positioned within a bolt aperture 70 of tap block 68a applies a force to first pipe 62. If a bolt 72 were positioned within bolt aperture 70 of tap block 68b, it would apply a force to second pipe 64. Utilizing a bolt 72 in tap block 68b may not be required when chain 11 is positioned on second pipe 64 as chain 11 applies a force to second pipe 64, however utilizing bolt 72 in tap block 68b can result in load equalization on chain 11 if needed. It will be understood by a person skilled in the art that, in general, when a single bolt 72 is used, it will be used to apply a force to the pipe which chain 11 is not attached.

Referring to FIG. 20, single alignment bar 56 may be used in association with a first chain 58 and a second chain 60 to assist in aligning first pipe 62 and second pipe 64. Single alignment bar 56 is attachable to chain links 12 on each of first chain 58 and second chain 60. In the embodiment shown in FIG. 15 through FIG. 17, single alignment bar 56 has a base 66 that corresponds in shape to t-slot 27, shown in FIG. 5. This allows base 66 of single alignment bar 56 to be slidingly engageable within t-slot 27. It will be understood that base 66 may be attachable to chain link 12 in any other suitable way known to a person skilled in the art. Single alignment bar 56 has an elongated body 67 with two tap blocks 68a and 68b. Tap block 68a extends beyond first chain 58 and tap block 68b extends beyond second chain 60 such that single alignment bar traverses the distance between first chain 58 and second chain 60 and assists with alignment of first pipe 62 and second pipe 64. Tap blocks 68a and 68b have bolt apertures 70 that accept bolts 72. Bolts 72 apply a force to at least one of first pipe 62 and second pipe 64 to assist with alignment. Tap blocks 68a and 68b may provide load equalization if needed for pipe chain system 10.

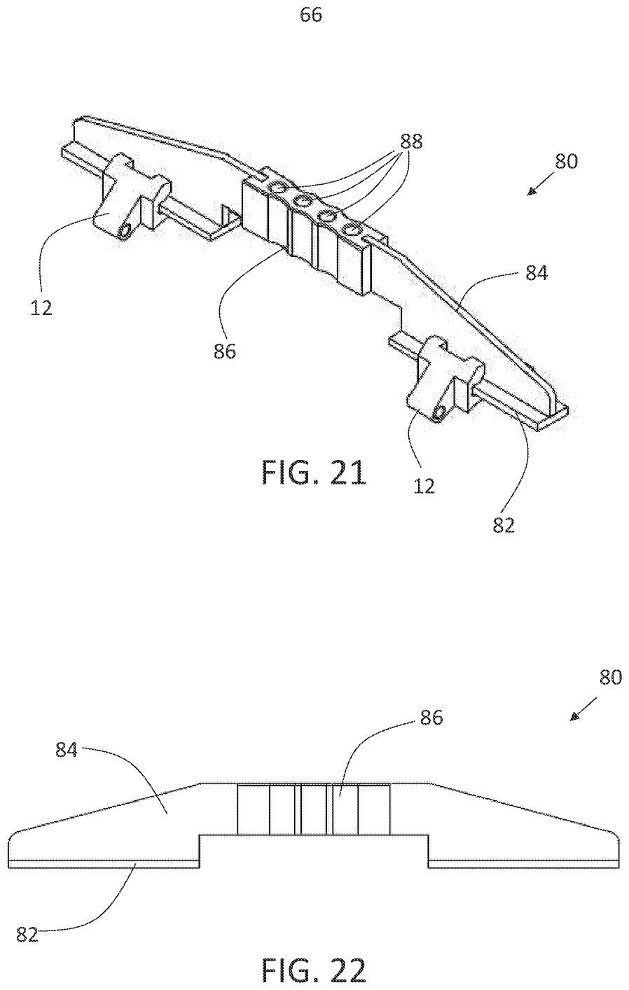

In the embodiment shown in FIG. 21 through FIG. 24, a double alignment bar 80 is shown. Double alignment bar 80 has a base 82 that attaches to at least one of chain links 12. In the embodiments shown, shape of base 82 corresponds in shape to t-slot 26, shown in FIG. 5. This allows base 82 of double alignment bar 80 to be slidingly engageable within t-slot 27, shown in FIG. 5. The sliding engagement between base 82 of double alignment bar 80 and t-slot 27 allows simultaneous alignment and positioning of pipes since double alignment bar 80 can slide in t-slot 27 during use. It will be understood that base 82 may be attachable to chain link 12 in any other suitable way known to a person skilled in the art. Base 82 may be a single body or two or more portions. Double alignment bar 80 has an elongated body 84 that attaches to base 82. A tap block 86 is positioned on elongated body 84. In the embodiment shown, tap block 86 is positioned centrally on elongated body 84. Tap block 86 has at least one tapped hole 88. In the embodiment shown, there are four tapped holes 88, however it will be understood by a person skilled in the art that different numbers of tapped holes 88 may be used.

Referring to FIG. 24, each of tapped holes 88 is capable of accepting a bolt 72. Bolts 72 apply a pushing force of at least one of first pipe 62 and second pipe 64. When in use, double alignment bar 80 is used in conjunction with first chain 58 and second chain 60. First chain 58 is positioned adjacent an end of first pipe 62 and second chain 60 is positioned adjacent an end of second pipe 64. Bolts 72 are positioned within tap block 86 such that one of bolts 72 contacts first pipe 62 and another of bolts 72 contacts second pipe 64.

Pipe chain system 10 is capable of replacing a number of traditional tools depending upon how chain 11 is used and whether a single chain is used or chains are paired together. Pipe chain system 10 may act as a comealong or sling which are often used to positioned pipes in a linear fashion and are used to pull pipes together or apart. A series of chain links 12 to form chain 11 in association with an actuator such as jack 38 may be used for this purpose. When clamp assembly 40 is included within chain 11, pipe chain system 10 may act as a sleeve clamp which is used to squeeze sections of pipe cut in half tight over an existing pipe to form a patch. When clamp assembly 40 and alignment bars 56 and/or alternative alignment bar 80 are used, pipe chain system 10 may be used as a single chain clamp, double clamps, cage clamps and positioning cages. The modular nature of pipe chain system 10 allows it to be used in a large number of situations where previously many different tools and equipment were required. The modular nature of pipe chain system 10 allows it to be manually installed even when large size tools are required that would traditionally require cranes or other lifting equipment.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. A pipe chain system, comprising:
a chain having a plurality of chain links, each chain link having a body, the body having a male end and a female end such that the male end matingly engages with the female end of an adjacent chain link, the body having an arcuate underside, the arcuate underside having an arc length equal to or smaller than an arc length corresponding to a portion of a pipe diameter to which the plurality of chain links is being attached;
a pin connection for mating each mating engagement of the male end and the female end of the adjacent chain links such that the chain links are hingedly connected to each other.

2. The pipe chain system of claim 1 wherein the body of the chain link has a flat topside.

3. The pipe chain system of claim 1 wherein the body is machined from a solid piece of steel.

4. The pipe chain system of claim 1 wherein each of the male end and the female end of the body have apertures positioned horizontally through the body such that the pin connection engages the apertures to cause mating of the male end and the female end of the adjacent chain links.

5. The pipe chain system of claim 1 wherein the body of the chain link has a topside having a t-slot.

6. The pipe chain system of claim 1 wherein a link ear having a base and a pair of upright arms is provided, the upright arms having component apertures in spaced alignment with each other, the link ear being fastened to a topside of the body.

7. The pipe chain system of claim 6 wherein the link ear is fixedly fastened to the topside of the body.

8. The pipe chain system of claim 6 wherein the link ear is rotatably fastened to the topside of the body.

9. The pipe chain system of claim 6 wherein an actuator is connected to the first body having the first link ear and the second body having the second link ear such that the actuator applies and releases a lateral load force on the pipe chain.

10. The pipe chain system of claim 1 further comprising a clamp assembly having a trunnion attached to the body of one of the chain links, the trunnion supporting a first end of a threaded rod, a hooked body is supported on a second end of the threaded rod, an adjustment knob positioned on the threaded rod such that rotation of the adjustment knob in a first direction causes the trunnion and the hooked body to move towards each other and rotation of the adjustment knob in a second direction causes the trunnion and the hooked body to move away from each other, the hooked body being hingedly attachable to one of the chain links.

11. The pipe chain system of claim 1 further comprising an alignment bar, the alignment bar having a base and two tap blocks, the base being attachable to at least one of the chain links, the two tap blocks being attachable to the base and positioned in opposition to each other.

12. A pipe chain system, comprising:
a first chain and a second chain each comprising:
a plurality of chain links, each chain link having a body, the body having a male end and a female end such that the male end matingly engages with the female end of adjacent chain links, the body having an arcuate underside, the arcuate underside corresponding to a portion of a pipe diameter to which the pipe chain is being attached;
a pin connection for mating each mating engagement of the male end and the female end of the adjacent chain links such that the chain links are hingedly connected to each other;
the first chain being positioned adjacent an end of a first pipe and the second chain being positioned adjacent an end of a second pipe, the end of the first pipe and the end of the second pipe being adjacent to each other;
an alignment bar extending from the first chain to the second chain such that the alignment bar extends over the end of the first pipe and the end of the second pipe for aligning the first pipe and the second pipe, the alignment bar being attachable to the chain link on each of the first chain and the second chain.

13. The pipe chain system of claim 12 wherein at least the chain link to which the alignment bar is attachable on both the first chain and the second chain has a topside having a t-slot, the alignment bar having a base corresponding in shape to the t-slot such that the base of the alignment bar is slidingly engageable within the t-slot.

14. The pipe chain system of claim 12 wherein each of the male end and the female end of the body have apertures positioned horizontally through the body such that the pin connection engages the apertures to cause mating of the male end and the female end of an adjacent chain link.

15. The pipe chain system of claim 12 wherein a link ear having a base and a pair of upright arms is provided, the upright arms having component apertures in spaced alignment with each other, the link ear being fastened to a topside of the body.

16. The pipe chain system of claim 15 wherein the link ear is fixedly fastened to the topside of the body.

17. The pipe chain system of claim 15 wherein the link ear is rotatably fastened to the topside of the body.

18. The pipe chain system of claim 15 wherein an actuator is connected to the first body having the first link ear and the second body having the second link ear such that the actuator applies and releases a lateral load force on the pipe chain.

19. The pipe chain system of claim 12 further comprising a clamp assembly having a trunnion attached to the body of one of the chain links, the trunnion supporting a first end of a threaded rod, a hooked body being supported by a second end of the threaded rod, an adjustment knob positioned on the threaded rod such that rotation of the adjustment knob in a first direction causes the trunnion and the hooked body to move towards each other and rotation of the adjustment knob in a second direction causes the trunnion and the hooked body to move away from each other, the hooked body being hingedly attachable to one of the chain links.

20. The pipe chain system of claim 12 wherein the alignment bar comprises a tap block having at least one tapped hole, each of the tapped holes accepting a bolt, the bolts being positioned above at least one of the first pipe and the second pipe to be aligned, the bolts applying a pushing force on at least one of the first pipe and the second pipe.

21. The pipe chain system of claim 13 wherein the alignment bar has a base and two tap blocks, the base being attachable to at least one of the chain links, the two tap blocks being attachable to the base and positioned in opposition to each other.
